(19) United States
(12) Patent Application Publication
(10) Pub. No.: US 2003/0003247 A1
(43) Pub. Date: Jan. 2, 2003

(54) Tubiform wired ribbon and method and apparatus for making same

(76) Inventors: Michael R. Salomon, Langhorne, PA (US); Kurt D. Salomon, Langhorne, PA (US)

Correspondence Address: DANN DORFMAN HERRELL & SKILLMAN, SUITE 720, 1601 MARKET STREET, PHILADELPHIA, PA, 19103-2307, US

(21) Appl. No.: 09/892,715

(22) Filed: Jun. 27, 2001

(51) Int. Cl. B42B 5/04; B32B 1/08

(52) U.S. Cl. 428/35.2; 412/36

(57) ABSTRACT

This invention relates to decorative tubiform wired ribbon and to a method and machine for making such ribbon. More specifically, a tubiform fabric or plastic ribbon is described that is edged with wire and trimmed with an overlay of decorative thread. The ribbon may also include a decorative insert such as a string of electric lights. According to the invention, the decorative ribbon is formed from two-plies of fabric that are edged with wire and tightly bound with a binding filament and a trim filament. The ribbon according to this invention is formed using a two-step process. The result is a unique tubiform construction, which has many desirable properties. The tubiform ribbon made in accordance with the invention is flexible, but will retain its shape when bent, twisted, or tied into a desired configuration. It is elegantly simple in design and provides a unique streamlined finished product with components that are firmly bound together. A method and an apparatus for making the tubiform wired ribbon are also described.

### FIELD OF THE INVENTION

This invention relates to decorative tubiform wired ribbon and to a method and apparatus for making the same. More specifically, the invention relates to tubiform fabric or plastic ribbons that are formed of two-ply fabric that is edged with wire and trimmed with an overlay of decorative thread and which can include a decorative insert.

### BACKGROUND OF THE INVENTION

Decorative fabric ribbons are known, as are fabric ribbons that have been edged with wire. However, the prior art wire ribbons are made by laying a wire near the edge of a fabric ribbon, folding the edge of the ribbon over the wire, and sewing or gluing down the folded edge to hold the wire in place.

This type of construction provides a ribbon that will retain its shape when bent, but which suffers from several significant disadvantages.

The folded edge in these known ribbons produces an unsightly seam, which gives the ribbon a definite front and a back, and which makes if more difficult to fashion the ribbon into pleasing shapes.

When the fabric edge is sewn down, the wire is only loosely held within a fabric sleeve, and thus it can move apart from the ribbon. This makes it more difficult to shape the ribbon, and a sliding wire can result in excess wire at one end of the ribbon and no wire at the other end. The sliding wire also makes the ribbon more difficult to control, and the ribbon is less likely to retain its shape over time. Side to side slippage of the wire can also cause undesirable bunching and/or buckling of the fabric.

Similar problems arise when glue is used. Although some glues may help keep the wire firmly in place, in general the bond is weak and cannot withstand the stress of normal use. Thus, the wire will eventually separate from the glue and ribbon over time, or when the ribbon is bent, twisted or tied in use. In addition, the application of the glue and the remove of excess glue results in significant production and quality control problems. For example, excess glue can deface the fabric ribbon, and glues of sufficient strength to hold the wire in place can degrade the fabric.

Another known method involves loosely sealing a wire between two laminated and/or embossed surfaces, which disadvantageously requires the use of two independent fabric surfaces. These ribbons typically are bulky and have an unsightly rear face. Additionally, the two surfaces have a tendency to separate, which defeats the purpose of having a reliable wired ribbon.

In view of these disadvantages, a need has arisen for an improved decorative wired ribbon, especially one that provides a firm and integral union of fabric and wire, without the undesirable folds, seams and glue of prior ribbons.

### SUMMARY OF THE INVENTION

Accordingly, it is an object of this invention to overcome the disadvantages of known wired ribbons, by providing a fabric or plastic tubular ribbon edged with wire and bound with trim, so that the wire is hidden from view and yet is firmly affixed to the ribbon without folds, seams or glue.

It is also another objective of the invention to show that after the ribbon has been made tubular it can be filled with electric lighting or any other product that allows for bending and shaping and creating a decorative tube or ribbon.

It is also another objective of the invention to provide a method of making tubular ribbons edged with wire and bound with decorative trim.

It is yet another objective to provide an apparatus for making the tubiform ribbons of the invention.

In accordance with one aspect of the present invention there is provided a tubiform wired ribbon that includes a first layer of ribbon material having a first edge and a second edge and a second layer of ribbon material having a first edge and a second edge. The first and second layers overlay one another such that their respective first and second edges are in substantial alignment and form a first ribbon edge and a second ribbon edge, respectively. The tubiform wired ribbon also includes a first wire filament aligned longitudinally adjacent the first ribbon edge. The first wire filament is attached to the ribbon by a first trim filament looped around said first wire filament and the first ribbon edge and a first binding filament that passes through the first and second layers of ribbon material for securing the first trim filament to said first and second layers of ribbon material adjacent the first ribbon edge. In this manner the first wire filament is held in place along said first ribbon edge and the first edges of the first and second layers of ribbon material are bound together. A second wire filament is attached to an opposite edge of the ribbon in the same manner.

In a preferred embodiment of the tubiform wired ribbon according to this invention, a decorative insert, such as string of electric lights, is provided between the two layers of ribbon fabric.

In accordance with a second aspect of the present invention there is provided an apparatus for making a decorative tubiform wired ribbon. The apparatus includes a stitching apparatus that has a work plate, a needle, a filament looper, and a needle plate disposed within and generally coplanar with the work plate. The needle plate is positioned above the filament looper and for the needle to pass therethrough. The needle plate has a tine that extends in a stitching direction. The apparatus also includes means for feeding a tubiform wired ribbon as set forth above through the stitching apparatus and means for drawing the tubiform wired ribbon through the stitching apparatus. A feed tube is mounted on the stitching apparatus adjacent to the tubiform wired ribbon feeding means so that a decorative insert can be inserted into the tubiform wired ribbon as it is drawn through the stitching apparatus.

In accordance with a further aspect of the present invention there is provided a method of making a decorative tubiform wired ribbon. The method includes the step of overlaying a first ply of a ribbon fabric having first and second edges and a second ply of a ribbon fabric having first and second edges such that the first and second edges of each ply are substantially aligned. The said first and second plies thus form a layered ribbon. A first wire filament is positioned along the first edge of the layered ribbon and is attached to the first edge of the layered ribbon in a continuous operation as follows. A first trim filament is looped around the first wire filament and the first edge of the layered ribbon and a first binding filament is passed through the layered ribbon to secure the first trim filament to the layered ribbon adjacent the first edge thereof. In this manner, the first wire filament is held in place along the first edge of the layered ribbon and the first edges of the first and second layers of ribbon fabric are bound together.

The invention and specific examples and embodiments thereof are further described in connection with the following drawings and detailed description.

### BRIEF DESCRIPTION OF THE DRAWINGS

The foregoing summary as well as the following detailed description of a preferred embodiment of the present invention will be better understood when read with the appended drawings, wherein:

FIG. 1 is a schematic view of a tubiform ribbon according to the present invention showing the arrangement of the wire filament, the trim filament, and the binding filament along one edge thereof;

FIG. 2A is a schematic diagram showing an arrangement for guiding the fabric as it is fed toward a stitching machine;

FIG. 2B is a side elevation view of the fabric guide shown in FIG. 2A;

FIG. 3 is a perspective view of a stitching apparatus according to the present invention;

FIG. 4 is a top plan view of a needle plate used in the stitching apparatus of FIG. 3;

FIG. 5 is a side elevation view of the needle plate shown in FIG. 4 with the wire filament adjacent thereto;

FIG. 6 is a bottom plan view of the needle plate shown in FIG. 4;

FIG. 7 is a perspective view of a tubiform ribbon according to the present invention that is assembled on one side only;

FIG. 8 is a perspective view of a stitching apparatus according to this invention showing the process of encapsulating a strand of lights within the tubiform ribbon; and

FIG. 9 is a plan view of a section of tubiform wired ribbon according to the invention including a string of electric lights inserted therein.

### DETAILED DESCRIPTION OF THE INVENTION

The tubiform ribbon of the invention is fabricated with two or panels pieces of fabric, a wire filament, at least one decorative or trim filament, and at least one binding filament. The trim and wire filament are firmly bound and affixed to the fabric by the binding filament. In a preferred embodiment, this is achieved in one simultaneous and continuous operation. Also, the binding filament is preferably chosen and the trim filament is applied in a size, quantity and manner such that the wire filament and binding filament are both substantially or even completely hidden by the trim filament. The tubiform ribbon may also include a decorative insert such as a string of electric lights encapsulated therein.

This arrangement provides a seamless stitched border that holds the wire filament in place without slippage, and without intermediate folding, gluing, embossing or laminating steps. The seamless stitched border can be formed in a single continuous operation.

The ribbon fabric can be any known fabric, either textile or plastic, and either flat or pleated.

Preferred finished ribbon sizes according to the invention are widths of 4″, 6″, 10″ up to 45″.

Pleated fabric can be obtained from flat fabric, for use in this invention, according to known means of pleating or texturing fabrics. Typically, a flat fabric is run through a pleating machine that is provides with knives. The fabric is scored with the knives, to produce the textured or pleated effect, which is preserved by heat treating the scored fabric to a temperature of about 250-300° F. The pleated fabric is sandwiched between holding paper and rolled for storage, so that the pleats retain their shape without damage.

The wire filament can be any flexible filament that will hold its shape without breaking when bent or twisted. The preferred wire filament of the invention is galvanized steel, which can range in gauge from about 20 to 32. The wire filament should be both strong and light, and the preferred size for ribbons ranging in width from 4 to 45 inches, is gauge 20 galvanized steel wire.

The trim filament of the invention can be any known decorative thread of a suitable strength and thickness, which can be wound around the wire filament and through the fabric on a needle, without breaking or snagging, and with enough weight and body to substantially or completely cover the wire filament. Metallic threads are particularly suitable, especially those comprising a metallic strand wrapped with one or two nylon strands. It has been found that a metallic strand that is 1/69th of an inch thick, or about 150 gauge, that is wrapped with one, or preferably two strands of 70 denier nylon strands is especially preferred. Non-metallic threads can also be used. According to the invention, threads ranging in thickness from 1/100th to 1/50th of an inch, and wrapped with one or two strands (or ends) of nylon ranging from 50 to 90 denier can be used.

The binding filament can be any filament chosen for strength and light weight, and preferably is one strand of monofilament ranging in thickness from 0.005 mil. to 0.009 mil. The preferred monofilament is 0.007 mil. in thickness.

The novel decorative ribbon of the invention is made by binding the wire filament and the trim filament to the fabric ribbon with the binding filament in one operation that both fixes the wire to the edge of the fabric, and hides the wire from view by covering it with turns of trim filament. This is done on a feed-driven stitching machine that is specially modified according to the invention, as further described below. Thus, the stitching machine supplies the fabric ribbon with a coextensive length of wire filament that is simultaneously bound to the fabric by the binding filament and covered over by the trim filament.

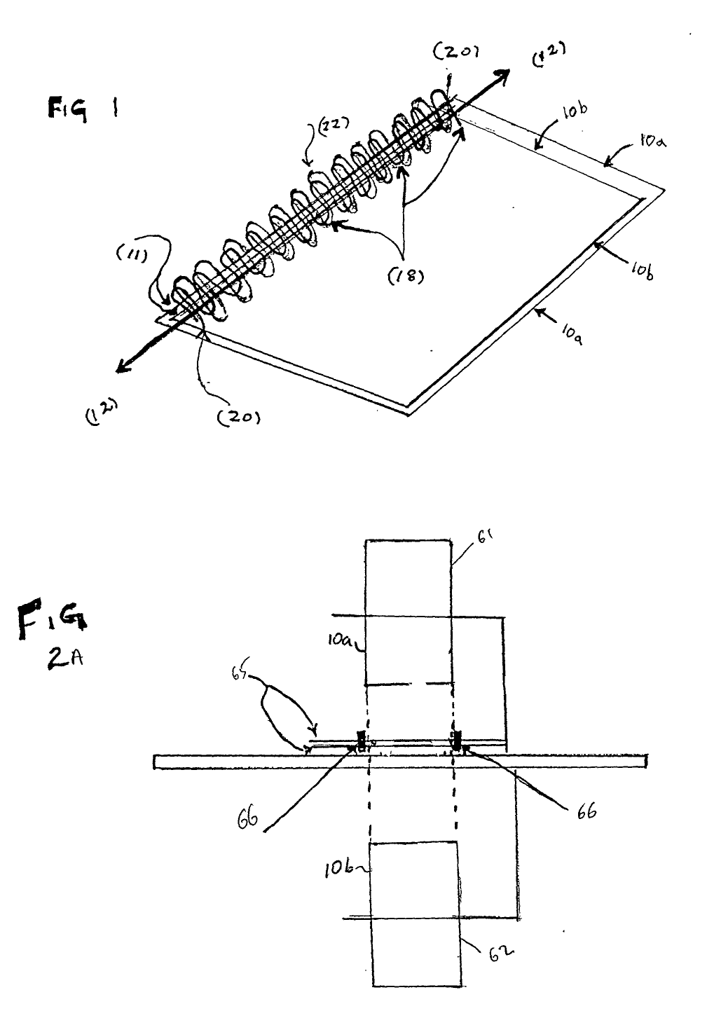

Referring now to the drawings, wherein like reference numerals refer to the same components across the several views, and in particular to FIG. 1, there is shown a portion of a tubiform ribbon including an edge wire secured according to the present invention. The ribbon 10 includes a first ply 10a and a second ply 10b having edges 11a and 11b respectively. An actual edge 11 of ribbon 10 is formed by the alignment of edges 11a and 11b. In this particular embodiment, a galvanized steel wire filament 12 is positioned along the actual edge 11 of the ribbon 10. The wire filament 12 is secured to the ribbon 10 by a sewing stitch, such as the purl stitch shown. In this embodiment, the stitch includes two filaments, a decorative trim filament 18 and a binding filament 20.

The purpose of the trim filament 18 is to substantially or entirely cover the wire filament 12 and the actual edge 11, thereby providing a clean, continuous and decorative edging to the ribbon 10. This can be achieved, as shown, by applying the trim filament 18 in a curved serpentine fashion over both the wire filament 12 and the actual edge 11 of the ribbon 10. The serpentine shape of the trim filament includes loops 22.

During the stitching process, the binding filament 20 pierces the ribbon 10 and inter-weaves through the serpentine loops 22 of the trim filament 18 to bind the trim filament 18 to the ribbon fabric. The binding filament 20 is kept taut during the stitching process, and the trim filament 18 and the interposed edge portion of the ribbon are pulled into engagement with the inner wire filament 12. In this way, the decorative trim filament 18 becomes substantially wrapped around the otherwise exposed edge 11 and the ribbon 10, all of which are securely bound together by the binding filament 20. Thus, the tight stitch created by the binding and trim filaments, acting together, not only secures the wire filament 12 to the ribbon 10, but also provides a decorative edging to the ribbon 10. In a preferred embodiment, the binding filament is a natural monofilament, chosen for its strength and also to be effectively invisible. This allows the trim filament to be prominently seen, so that the ribbon is provided with a securely wired and decorative edge.

A similar arrangement of wire filament, decorative or trim filament and binding filament is applied in a similar manner to the opposite edge of ribbon 10. In this way the resulting tubiform ribbon product has a tightly secured hidden wire filament 12 along each edge of the ribbon material to support the ribbon's shape, and a decoratively disguised stitch that provides an attractive edging on each side of the ribbon.

FIG. 7 shows a portion of a partially finished ribbon according to the invention having one edge wired, and stitched together.

Additionally, the present invention provides an improved adaptation to a conventional high speed stitching machine to create the secured wire ribbon-edge arrangement of the present invention. Two examples of conventional high speed stitching machines are the Merrow High Speed Trimming & Overseaming Machine manufactured by the Merrow Company of Hartford, Conn., and the Pegasus S32 manufactured by the Pegasus Sewing Machine Manufacturing Co., Ltd. of Osaka, Japan.

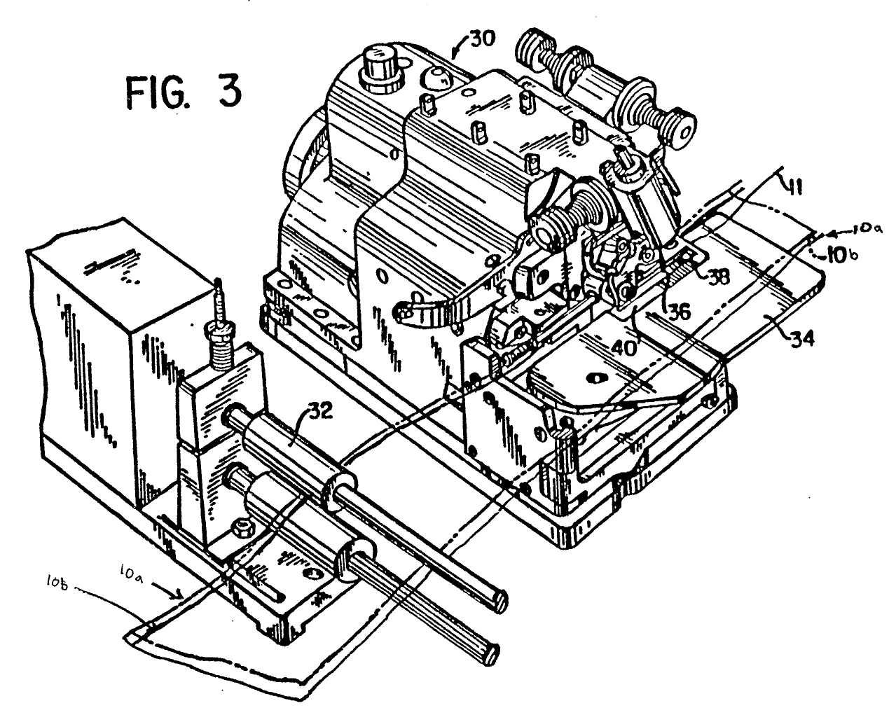

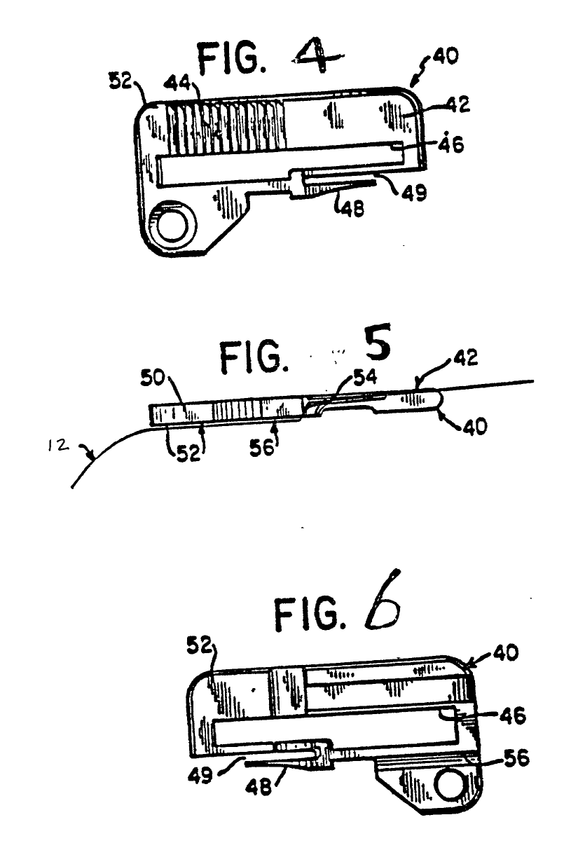

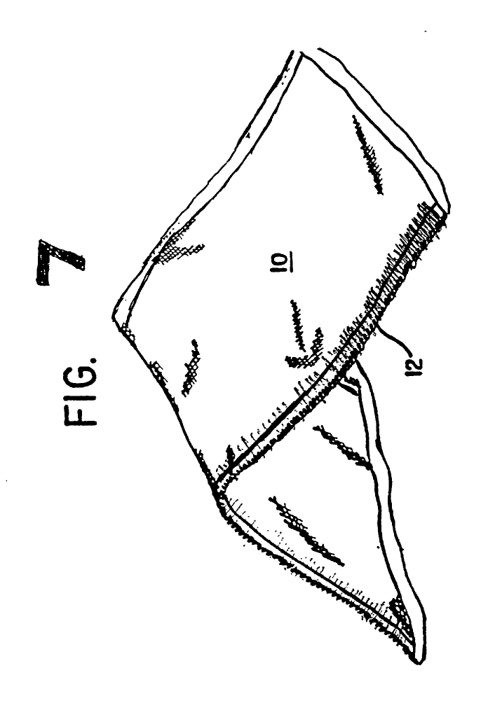

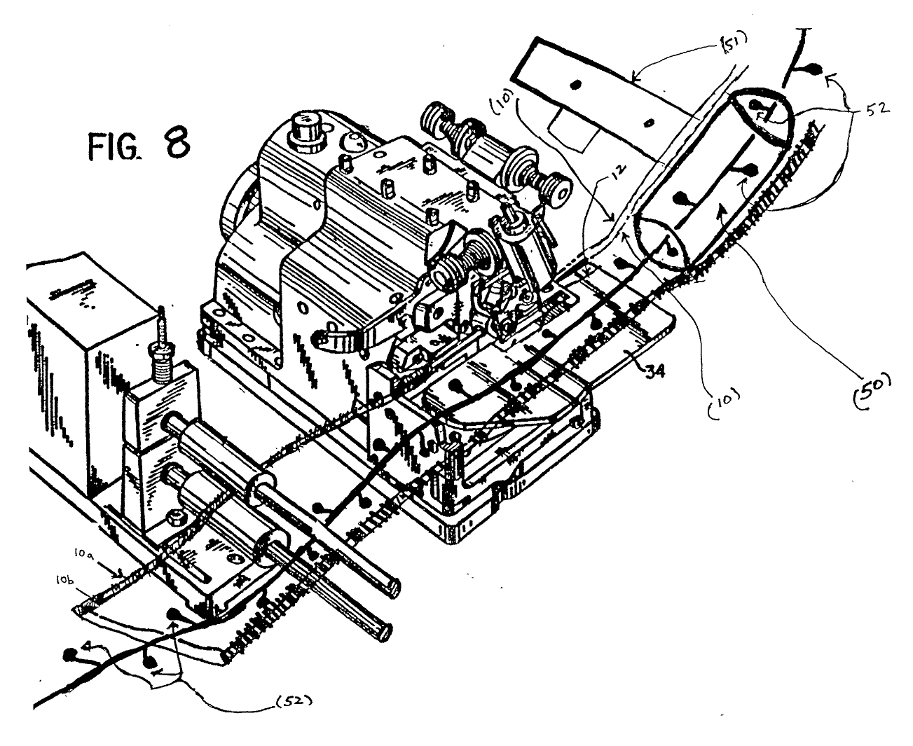

Referring now to FIG. 3, the stitching machine 30 which is adjacent to guide rollers 32 includes a work plate 34 for supporting the ribbon 10. The machine 30 also includes a moveable sewing needle 36, a feed carrier 38 for feeding the ribbon 10, and a needle plate 40, which is recessed into and generally coplanar with the work plate 34.

The guide rollers 32 are preferably power driven using conventional methods so that the ribbon 10 is drawn from the work plate 34 of the stitching machine 30 in synchronization with the stitching operation. The purpose of the rollers 32 is to maintain tension and prevent buckling in the ribbon 10 during stitching and after it has been stitched. If the ribbon 10 is not pulled from the stitching machine 30, the stitch can become distorted or otherwise uneven and unattractive and the various elements of the invention, such as the ribbon, wire and filaments, will not be secured in a satisfactory manner.

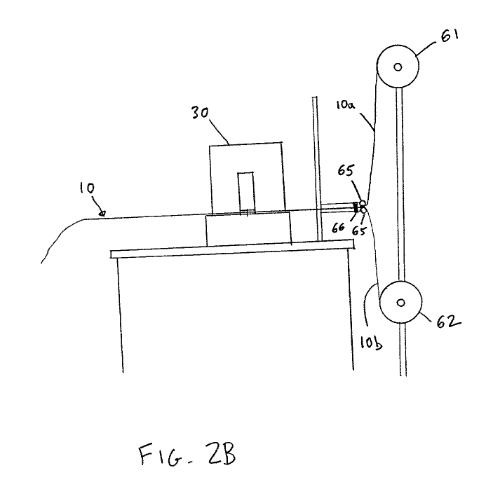

The drive speed of the rollers 32 is dictated by the feed rate established by the internal feed carrier 38, typically protruding from within the needle plate 40. The feed carrier 38 pulls one ply of ribbon material 10a from an upper supply roll 61 and a second ply of ribbon material 10b from a lower supply roll 62 as shown in FIGS. 2A and 2B. As the two-plies of ribbon material 10a and 10b are drawn into the stitching apparatus 30, they are pulled through a pair of guide bars 65 and a pair of guiders 66, to vertically and horizontally align the two-plies for stitching. It is conventionally known that the drive speed of the guide rollers 32 and the feedrate of the feed carrier 38 should be matched during high speed edge stitching so that the ribbon 10 can be drawn from the supply rolls, stitched, and drawn in a smooth flow. The ribbon may subsequently be drawn onto a collection roll, or some other means of storage.

A typical edge stitch comprises two filaments of thread. One thread is usually supplied to the fabric, which in this case is ribbon 10, by “loopers” from below the needle plate 40, while the other thread is fed to the needle 36 from above the needle plate 40. In the process according to the present invention, the first thread below the needle plate 40 is preferably the trim filament 18 and the second thread, which is fed to the needle above the needle plate 40, is preferably the binding filament 20. The normal operation of the stitching machine 30 provides a conventional stitch by interweaving the binding filament 20 with the trim filament 18, as further described below.

In accordance with another aspect of the present invention, a wire filament 12 is provided within the ribbon 10, before the stitch is produced by the stitching machine 30. An apparatus according to the present invention includes a needle plate 40 which has been modified such that a wire filament 12 can be guided and applied in a controlled manner onto the ribbon 10 during the stitching process. The needle plate 40 of the present invention is shown in FIGS. 4-6. The needle plate 40 includes a top portion 42 having fabric engagement teeth 44, a feed carrier access slot 46, a fabric support tine 48 for supporting the fabric adjacent to the moving needle, and a needle stitching slot 49. The needle plate 40 also includes a side portion 50 and a bottom portion 52. The side portion 50 includes a side groove 54 along the side of the support tine 48. The side groove 54 is of proper dimensions to effectively guide a sliding wire filament 12 of a chosen size from a wire filament source to the ribbon 10, specifically along the ribbon's edge. A similarly shaped bottom groove 56 is disposed substantially inline with that of the side groove 54. As shown in FIG. 5, the wire filament 12 is guided by both side and bottom grooves without stress or deformation. The wire filament 12 is first guided from its source, and under the work plate 34 by the bottom groove 56 along the bottom portion of the needle plate 40 and then, by the side groove 54 along the side of the support tine 48 adjacent to the top portion of the needle plate 40 where it is easily positioned on the ribbon's edge 11 and secured to the ribbon 10 during the stitching process.

In operation, a supply of an appropriate decorative trim filament 18 and a supply of binding filament 20 are loaded in a conventional manner into a standard stitching machine, like the preferred Merrow or Pegasus machine. The wire filament 12 is fed through the needle plate 40, guided by both the side groove 54 and the bottom groove 56 and is ultimately drawn with the ribbon by the rollers 32. The ribbon 10 is positioned in a conventional manner onto the work plate 34 of the stitching machine 30. The previously described stitch is then produced around the edges and the enclosed wire 12. The stitching process creates the necessary pull required to ensure tight engagement between the wire filament 12 and the ribbon 10.

The tightness of the stitch can be regulated by adjusting the cams of the stitching machine. In a preferred embodiment, the cams are adjusted so that the trim filament is wrapped tightly, with each turn of the filament just touching or overlapping each adjacent turn, so that the wire and the edge of the ribbon are covered over. It will also be appreciated by skilled practitioners that more than one trim filament or binding filament can be used.

Preferably, one or two trim filaments is used and one binding filament is used.

An alternative method of binding the edges of the two-ply ribbon may be used. In the alternative technique a strip of fabric is folded over the edge of the decorative ribbon so as to straddle the wire filament and the edges of the fabric layers. The strip is drawn along with the ribbon by the stitching machine and stitched so that the wire filament is encapsulated and the edges of the ribbon fabric are bound together. The strand is stitched to the ribbon with a binding filament in a similar manner as previously described using a single needle stitch. If desired, one or more trim filaments may be stitched to the fabric along with the binding filament. The width of the fabric strand is preferably about ¼ inch, such that when folded it overlaps the edge of the decorative ribbon by approximately ⅛ inch. However, any width of strand may be used as would be desired depending on the particular application.

The above procedure is then duplicated, with modifications as described following, to stitch the opposite edge of the ribbon 10 and complete the tubiform wired ribbon. In this stage of the process, the decorative insert is encapsulated between the two plies of the ribbon fabric. Preferably, the decorative insert is a string of lights. However, other inserts could be used such as a string of LED's, confetti, glitter, or decorative shapes. If desired a decorative ribbon or yarn could be inserted. Of course, combinations of such decorative inserts could also be used.

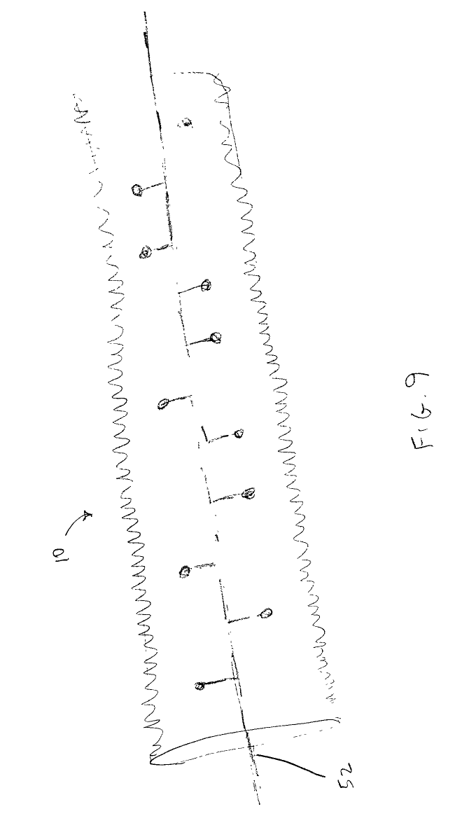

Referring now to FIG. 8, the process for performing the closing and encapsulating steps utilizes the same sewing equipment described above. A tubular member 50 is disposed at the front of the sewing machine to allow a string of electric lights 52 to pass inside of the two-ply ribbon while the fabric or plastic surrounds the tubular member 50 leading it toward the sewing machine 30. Tubular member 50 is mounted on a spring loaded holder 51, which is pivotable so that tubular member 50 may be rotated out of the way for non-encapsulating stitching processes.

The stitching apparatus 30 closes the second edge of the ribbon 10 by the same procedure as described above, thereby encapsulating the light string 52 within the tubiform ribbon. A section of the completed ribbon is shown in FIG. 9.

The tubiform wired ribbon was created to form a new decorative ribbon product with electric lights or other decorative insert to create a dynamic and unique product electric wired ribbon. This product can be used indoors and outdoors when fabricated from plastic. All lights are and should be UL approved for indoor and outdoor applications. All plastic fabric utilized in the decorative ribbon according to this invention is preferably water-proof, mildew-proof, and fade resistant. Fabrics other than plastic should be specially treated for flame-retardancy and used in conjunction with UL approved lighting.

While the present invention has been described in terms of the foregoing exemplary embodiments, variations within the scope and spirit of the present invention as defined by the claims following will be apparent to those of ordinary skill in the art.

What is claimed is:

1. A tubiform wired ribbon, comprising:
a first layer of ribbon material having a first edge and a second edge;
a second layer of ribbon material having a first edge and a second edge, said first and second layers overlaying one another such that their respective first and second edges are in substantial alignment and form a first ribbon edge and a second ribbon edge, respectively;
a first wire filament aligned longitudinally adjacent the first ribbon edge;
a first trim filament looped around said first wire filament and the first ribbon edge; and
a first binding filament passing through the first and second layers of ribbon material for securing the first trim filament to said first and second layers of ribbon material adjacent the first ribbon edge, such that the first wire filament is held in place along said first ribbon edge and the first edges of the first and second layers of ribbon material are bound together.

2. A tubiform wired ribbon as set forth in claim 1, further comprising;
a second wire filament aligned longitudinally adjacent the second ribbon edge;
a second trim filament looped around said second wire filament and the second ribbon edge; and
a second binding filament passing through the first and second layers of ribbon material for securing the second trim filament to said first and second layers of ribbon material adjacent the second ribbon edge, such that the second wire filament is held in place along said second ribbon edge and the second edges of the first and second layers of ribbon material are bound together.

3. A tubiform wired ribbon as set forth in claim 2, further comprising a decorative insert disposed between the first and second layers of ribbon material.

4. A tubiform wired ribbon as set forth in claim 3 wherein the decorative insert comprises a string of electric lights.

5. A tubiform wired ribbon, comprising:
a first layer of ribbon material having a first edge and a second edge;
a second layer of ribbon material having a first edge and a second edge, said first and second layers overlaying one another such that their respective first and second edges are in substantial alignment and form a first ribbon edge and a second ribbon edge, respectively;
a first wire filament aligned longitudinally adjacent the first ribbon edge;
a first strip of material folded in a straddling fashion around the first wire filament and the first ribbon edge; and
a first binding filament passing through the first and second layers of ribbon material for securing the first strip of material to said first and second layers of ribbon material adjacent the first ribbon edge, such that the first wire filament is held in place along said first ribbon edge and the first edges of the first and second layers of ribbon material are bound together.

6. A tubiform wired ribbon as set forth in claim 5 further comprising a second wire filament aligned longitudinally adjacent the second ribbon edge;
a second strip of material folded in a straddling fashion around the second wire filament and the second ribbon edge; and
a second binding filament passing through the first and second layers of ribbon material for securing the second strip of material to said first and second layers of ribbon material adjacent the second ribbon edge, such that the second wire filament is held in place along said second ribbon edge and the second edges of the first and second layers of ribbon material are bound together.

7. A tubiform wired ribbon as set forth in claim 5, further comprising a decorative insert disposed between the first and second layers of ribbon material.

8. A tubiform wired ribbon as set forth in claim 7 wherein the decorative insert comprises a string of electric lights.

9. Apparatus for making a decorative tubiform wired ribbon comprising:
a stitching apparatus that includes a work plate, a needle, a filament looper, and a needle plate disposed within and generally coplanar with the work plate, said needle plate being positioned above the filament looper and for the needle to pass therethrough, and said needle plate having a tine that extends in a stitching direction;
means for feeding a tubiform wired ribbon as set forth in claim 1 through said stitching apparatus;
means for drawing the tubiform wired ribbon through said stitching apparatus; and
a feed tube mounted on said stitching apparatus adjacent to said tubiform wired ribbon feeding means such that a decorative insert can be inserted into the tubiform wired ribbon through said feed tube as the tubiform wired ribbon is drawn through said stitching apparatus.

10. A method of making a decorative tubiform wired ribbon comprising the steps of:
overlaying a first ply of a ribbon fabric having first and second edges and a second ply of a ribbon fabric having first and second edges such that the first and second edges of each ply are substantially aligned, said first and second plies forming a layered ribbon having first and second ribbon edges;
positioning a first wire filament along the first ribbon edge; and
attaching the first wire filament to the first ribbon edge in a continuous operation comprising the steps of:
looping a first trim filament around said first wire filament and the first ribbon edge; and
passing a first binding filament through the layered ribbon to secure the first trim filament to said layered ribbon adjacent the first ribbon edge, such that the first wire filament is held in place along said first ribbon edge and such that the first edges of the first and second layers of ribbon fabric are bound together.

11. A method as set forth in claim 10 further comprising the steps of:
positioning a second wire filament along the second ribbon edge; and
attaching the second wire filament to the second ribbon edge in a continuous operation comprising the steps of:
looping a second trim filament around said second wire filament and the second ribbon edge; and
passing a second binding filament through the layered ribbon to secure the second trim filament to said layered ribbon adjacent the second ribbon edge, such that the second wire filament is held in place along said second ribbon edge and such that the second edges of the first and second layers of ribbon fabric are bound together.

12. A method as set forth in claim 10 further comprising the steps of:
inserting a decorative insert between the first and second plies of ribbon fabric; and then positioning a second wire filament along the second ribbon edge; and
attaching the second wire filament to the second ribbon edge in a continuous operation comprising the steps of:
looping a second trim filament around said second wire filament and the second ribbon edge; and
passing a second binding filament through the layered ribbon to secure the second trim filament to said layered ribbon adjacent the second ribbon edge, such that the second wire filament is held in place along said second ribbon edge and such that the second edges of the first and second layers of ribbon fabric are bound together.

13. A method as set forth in claim 12 wherein the step of inserting a decorative insert comprises the step of inserting a string of electric lights.
